(19) United States
(12) Patent Application Publication
(10) Pub. No.: US 2005/0278613 A1
(43) Pub. Date: Dec. 15, 2005

(54) Topic analyzing method and apparatus and program therefor

(75) Inventors: Satoshi Morinaga, Tokyo (JP); Kenji Yamanishi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/147,290

(22) Filed: Jun. 8, 2005

(30) Foreign Application Priority Data
Jun. 9, 2004 (JP) 170612/2004

(51) Int. Cl. G06F 15/00; G06F 17/00; G06F 17/21; G06F 17/24

(52) U.S. Cl. 715/500; 715/531

(57) ABSTRACT

A topic analyzing method is provided in which the number of main topics in text data which is added in time series and generation and disappearance of topics are identified in real time as needed, and features of main topics are extracted and thereby one can know a change in the content of a topic with a minimum amount of memory and processing time. There is provided a system that detects topics while sequentially reading text data in a situation where the text data is added in time series, including learning means for representing a topic generation model by a mixture distribution model and learning the topic generation model online while more-heavily discounting the older data on the basis of a timestamp of the data; and model selecting means for selecting an optimal topic generation model from among a plurality of candidate topic generation models on the basis of information criteria of the topic generation models, wherein the topics are detected as mixture components of the optimal generation model.

### BACKGROUND OF THE INVENTION

1. Field of the Invention

The present invention relates to a topic analyzing method and an apparatus and program therefor and, in particular, to a topic analyzing method for identifying a main topic at each point of time in a set of texts to which texts are added in time series and analyzing contents of each topic and change in the topic, especially in the fields of text mining and natural language processing.

2. Description of the Related Art

Methods for extracting main expressions at each point of time from time-series text data given as a batch are known, such as the one described in Non-Patent Document 1 indicated below. In the method, words whose occurrence frequencies have risen in a certain period of time are extracted from among the words appearing in text data, and the starting time of the time period is used as the appearance time of a main topic, the end time of the period is used as the disappearance time of that topic, and the words are used as the representation of the topic.

A method is disclosed in Non-Patent Document 2 indicated below, in which time-series changes of topics are visualized. However, these two methods cannot deal with each of the words in sequentially provided data online in real time.

A method is disclosed in Non-Patent Document 3 indicated below, in which a cluster of time-series text containing a certain word is detected. Problems with this method are that it is not adequate for analyzing the same topics represented by different words and it cannot analyze topics in real time.

Methods are disclosed in Non-Patent Documents 4 and 5 indicated below, in which a finite mixture probability model is used to identify topics and detect changes in topics. However, neither of them can deal with each of the words in sequentially provided data online and in real time.

A method is described in Non-Patent Document 6 indicated below, in which a finite mixture probability model is learned in real time. Although the method takes the time-series order of data into consideration, it cannot reflect data occurrence time itself.

[Non-Patent Document 1] R. Swan, J. Allan, “Automatic Generation of Overview Timelines”, Proc. SIGIR Intl. Conf. Information Retrieval, pp. 49-56, 2000.

[Non-Patent Document 2] S. Harve, B. Hetzler, and L. Norwell, “ThemeRiver: Visualizing Theme Changes over Time”, Proceedings of IEEE Symposium on Information Visualization, pp. 115-123, 2000.

[Non-Patent Document 3] J. Kleinberg, “Bursty and Hierarchical Structure in Streams”, Proceedings of KDD2002, pp. 91-101, ACM Press, 2003.

[Non-Patent Document 4] X. Liu, Y. Gong, W. Xu, and S. Zhu, “Document Clustering with Cluster Refinement and Model Selection Capabilities”, Proceedings of SIGIR International Conference on Information Retrieval, pp. 191-198, 2002.

[Non-Patent Document 5] H. Li and K. Yamanishi, “Topic analysis using a finite mixture model”, Information Processing and Management, Vol. 39/4, pp. 521-541, 2003.

[Non-Patent Document 6] K. Yamanishi, J. Takeuchi and G. Williams, “On-line Unsupervised Outlier Detection Using Finite Mixtures with Discounting Learning Algorithms”, Proceedings of KDD2000, ACM Press, pp. 320-324, 2000.

Many of the conventional methods require a huge amount of memory capacity and processing time for identifying the contents of main topics at any time while pieces of text data are added in time series. However, when topics in text data to which data is added in time series for the purpose of CRM (Customer Relationship Management), knowledge management, or Web monitoring is to be analyzed, the analysis must be performed in real time by using as small an amount of memory capacity and processing time as possible.

Moreover, according to the methods described above, if the contents of a single topic changes subtly with time, the fact that “the topic is the same but its contents is changing subtly” cannot be known. However, in topic analysis for CRM or Web monitoring, a considerable knowledge can be obtained by identifying the contents of a single topic, such as extracting “changes in customer-complaints about a particular product.”

### SUMMARY OF THE INVENTION

An object of the present invention is to provide a topic analyzing method and an apparatus and program therefor that enable the number, appearance, and disappearance of main topics in text data which is added in time series to be identified in real time as needed and enable features of main topics to be extracted with a minimum amount of memory capacity and processing time, thereby enabling a human analyzer to know a change in a single topic.

According to the present invention, there is provided a topic analyzing apparatus that detects topics while sequentially reading text data in a situation where the text data is added over time, the apparatus including: learning means for representing a topic generation model by a mixture distribution model and learning the topic generation model online while more-heavily discounting the older data on the basis of a timestamp of the data; and model selecting means for selecting an optimal topic generation model from among a plurality of candidate topic generation models on the basis of information criteria of the topic generation models, wherein topics are detected as mixture components of the optimal topic generation model.

Another topic analyzing apparatus according to the present invention includes topic generation and disappearance determining means for comparing mixture components of a topic generation model at a particular time with mixture components of a topic generation model at another time to determine whether or not a new topic has been generated and whether or not an existing topic has disappeared.

Another analyzing apparatus according to the present invention includes topic feature representation extracting means for extracting a feature representation of a topic corresponding to each of the mixture components of a topic generation model on the basis of a parameter of the mixture components to characterize each topic.

According to the present invention, there is provided another topic analyzing apparatus that detects topics while sequentially reading text data in a situation where the text data is added in time series, the apparatus having: learning means for representing a topic generation model by a mixture distribution model and learning the topic generation model online while more-heavily discounting the older data on the basis of a timestamp of the data; and model selecting means for selecting an optimal topic generation model from among a plurality of candidate topic generation models on the basis of information criteria of the topic generation models; and including means for detecting topics as mixture components of the optimal topic generation model; and topic generation and disappearance determining means for comparing mixture components of a topic generation model at a particular time with mixture components of a topic generation model at another time to determine whether or not a new topic has been generated and whether or not an existing topic has disappeared.

According to the present invention, there is provided another topic analyzing apparatus that detects topics while sequentially reading text data in a situation where the text data is added in time series, the apparatus including: learning means for representing a topic generation model by a mixture distribution model and learning the topic generation model online while more-heavily discounting the older data on the basis of a timestamp of the data; model selecting means for selecting an optimal topic generation model from among a plurality of candidate topic generation models, on the basis of information criteria of the topic generation models; and topic feature extracting means for detecting topics as mixture components of the optimal topic generation model, extracting a feature representation of a topic corresponding to each of the mixture components of a topic generation model on the basis of a parameter of the mixture components, and characterizing each topic.

According to the present invention, there is provided a topic analyzing method for detecting topics while sequentially reading text data in a situation where the text data is added in time series, including the steps of: representing a topic generation model by a mixture distribution model, learning the topic generation model online while more-heavily discounting the older data on the basis of a timestamp of the data; and selecting an optimal topic generation model from among a plurality of candidate topic generation models, on the basis of information criteria of the topic generation models and detecting topics as mixture components of the optimal topic generation model.

Another topic analyzing method according to the present invention includes the step of comparing mixture components of a topic generation model at a particular time with mixture components of a topic generation model at another time to determine whether or not a new topic has been generated and whether or not an existing topic has disappeared.

Another topic analyzing method according to the present invention includes the step of extracting a feature representation of a topic corresponding to each of the mixture components of a topic generation model on the basis of a parameter of the mixture components to characterize each topic.

According to the present invention, there is provided another topic analyzing method for detecting topics while sequentially reading text data in a situation where the text data is added in time series, including the steps of: representing a topic generation model by a mixture distribution model and learning the topic generation model online while more-heavily discounting the older data on the basis of a timestamp of the data; selecting an optimal topic generation model from among a plurality of candidate topic generation models on the basis of information criteria of the topic generation models and detecting topics as mixture components of the optimal topic generation model; and comparing mixture components of a topic generation model at a particular time with mixture components of a topic generation model at another time to determine whether or not a new topic has been generated and whether or not an existing topic has disappeared.

According to the present invention, there is provided another topic analyzing method for detecting topics while sequentially reading text data in a situation where the text data is added in time series, including the steps of: representing a topic generation model by a mixture distribution model and learning the topic generation model online while more-heavily discounting the older data on the basis of a timestamp of the data; selecting an optimal topic generation model from among a plurality of candidate topic generation models on the basis of information criteria of the topic generation models and detecting topics as mixture components of the optimal topic generation model; and extracting a feature representation of a topic corresponding to each of the mixture components of a topic generation model on the basis of a parameter of the mixture components to characterize each topic.

According to the present invention, there is provided a program for causing a computer to perform a method for detecting topics while sequentially reading text data in a situation where the text data is added in time series, including the steps of: representing a topic generation model by a mixture distribution model and learning the topic generation model online while more-heavily discounting the older data on the basis of a timestamp of the data; and selecting an optimal topic generation model from among a plurality of candidate topic generation models on the basis of information criteria of the topic generation models and detecting topics as mixture components of the optimal topic generation model.

Another program according to the present invention includes the step of comparing mixture components of a topic generation model at a particular time with mixture components of a topic generation model at another time to determine whether or not a new topic has been generated and whether or not an existing topic has disappeared.

Another program according to the present invention includes the step of extracting a feature representation of a topic corresponding to each of the mixture components of a topic generation model on the basis of a parameter of the mixture components to characterize each topic.

According to the present invention, there is provided another program for causing a computer to perform a method for detecting topics while sequentially reading text data in a situation where the text data is added in time series, comprising the steps of: representing a topic generation model by a mixture distribution model and learning the topic generation model online while more-heavily discounting the older data on the basis of a timestamp of the data; selecting an optimal topic generation model from among a plurality of candidate topic generation models on the basis of information criteria of the topic generation models and detecting topics as mixture components of the optimal topic generation model; and comparing mixture components of a topic generation model at a particular time with mixture components of a topic generation model at another time to determine whether or not a new topic has been generated and whether or not an existing topic has disappeared.

According to the present invention, there is provided another program for causing a computer to perform a method for detecting topics while sequentially reading text data in a situation where the text data is added in time series, including the steps of: learning means for representing a topic generation model by a mixture distribution model and learning the topic generation model online while more-heavily discounting the older data on the basis of a timestamp of the data; selecting an optimal topic generation model from among a plurality of candidate topic generation models on the basis of information criteria of the topic generation models and detecting topics as mixture components of the optimal topic generation model; and extracting a feature representation of a topic corresponding to each of the mixture components of a topic generation model on the basis of a parameter of the mixture components to characterize each topic.

Operations of the present invention will be described. According to the present invention, each text is represented by a text vector and a mixture distribution model is used as its generation model. One component of the mixture distribution corresponds to one topic. A number of mixture distribution models consisting of different numbers of components are stored in model storage means. Each time new text data is added, learning means additionally learns parameters of the models and model selecting means selects the optimal model on the basis of information criteria. The components of the selected model represent main topics. If the model selecting means selects a model which differs from the previously selected one, topic generation and disappearance determining means compares the previously selected model with the newly selected one to determine which topics have been newly generated or which topics have disappeared.

According to the present invention, regarding each of the topics of the model selected by the model selecting means and the topics judged to be newly generated topics or disappeared topics by the topic generation and disappearance means, topic feature representation extracting means extracts a feature representation of the topic from relevant parameters of the mixture distribution and outputs it.

Rather than learning and selecting all of the multiple mixture distribution models, one or more higher-level models may be learned and a number of sub-models may be generated from the learned higher model or models by sub-model generating means, and an optimal model may be selected from the sub-models by the model selecting means. Furthermore, rather than generating and storing sub-models independently, information criteria of certain sub-models may be directly calculated from a higher-level model by sub-model generating and selecting means to select the optimal sub-model.

In additional learning parameters of the models by the learning means, greater importance may be placed on the content of text data that have arrived recently than that of old text data. Further, if timestamps are attached to text data, the timestamps may be used in addition to the order of arrival to place greater importance on recent text data than old text data.

To select an optimal model by the model selecting means or sub-model generating and selecting means, the distance between distributions before and after additional learning using newly inputted text data or how rare the inputted text data has emerged in the distribution before the additional learning may be calculated for every model, and the model that provides the minimum distance or rareness may be selected. The results of the calculation may be divided by the dimension of the models or values that accumulated from a certain time or an average weighted to place importance on recent values may be calculated.

In comparing the previously selected model (old model) with a newly selected model (new model), the topic generation and disappearance determining means may calculate the similarity between the components in every pair of components in the old and new models and may judge components of the new model that are dissimilar to any components of the old model to be newly generated topics and may judge components of the old model that are dissimilar to any components of the new model to be disappeared topics. The distance between average values or a p-value in an identity test may be used as the measure of the similarity between components. If a model is a sub-model generated from a higher-level model, the similarity between components may be determined on the basis of whether they are generated from the same component in a higher-level model.

In the topic feature representation extracting means, text data may be generated according to a probability distribution of components representing topics and a well-known feature extracting technique may be used to extract a feature representation of each topic by using the text data as an input. If statistics of the text data required for the well-known feature extracting technique can be calculated from parameters of components, the parameter values may be used to extract features. Sub-distribution generating means may use sub-distributions consisting of some of the components of a higher-level model.

### BRIEF DESCRIPTION OF THE DRAWINGS

FIG. 1 is a block diagram showing a configuration of a topic analyzing apparatus according to a first embodiment of the present invention;

FIG. 2 is a flowchart of an operation of the topic analyzing apparatus according to the first embodiment of the present invention;

FIG. 3 is a block diagram showing a configuration of a topic analyzing apparatus according to a second embodiment of the present invention;

FIG. 4 is a block diagram showing a configuration of a topic analyzing apparatus according to a third embodiment of the present invention;

FIG. 5 is an example of data inputted in the present invention;

FIG. 6 is a first example of an output result of analysis according to the present invention; and

FIG. 7 is a second example of an output result of analysis according to the present invention.

### DETAILED DESCRIPTION OF THE PREFERRED EMBODIMENTS

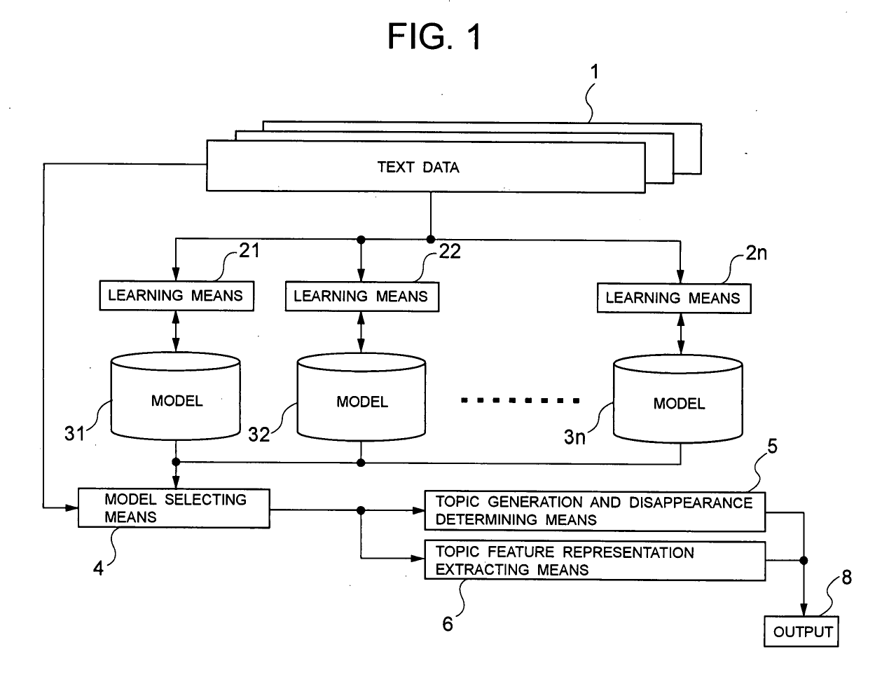

Embodiments of the present invention will be described below with reference to the accompanying drawings. FIG. 1 is a block diagram showing a configuration of a topic analyzing apparatus according to a first embodiment of the present invention. The topic analyzing apparatus as a whole is formed by a computer and include text data input means 1, learning means 21, . . . , 2n, a mixture distribution model (model storage means) 31, . . . , 3n, model selecting means 4, topic generation and disappearance determining means 5, topic feature representation extracting means 6, and output means 8.

The text data input means 1 is used for inputting text (text information) such as inquiries of users at a call center, contents of monitored pages collected from Web, and articles of newspapers, and allows data of interest to be inputted in bulk and also allows data to be added whenever it is generated or collected. Inputted text is parsed by using well-known morphological analysis techniques or syntactic analysis techniques and converted into a data format used in models 31, . . . , 3n, which will be described later, by using well-known attribute selection techniques and weighting techniques.

For example, nouns w1, . . . , wN may be extracted out of all words in text data and frequencies of appearances of the nouns in the text may be represented by tf (w1), . . . , tf (wN) and the vector (tf (w1), . . . , tf (wN)) may be used as the representation of the text data, or the total number of texts may be represented by M and the number of texts containing a word wi may be represented by df (wi) and the vector
(tf−idf (wi), . . . , tf−idf (wN))
having the value tf−idf such that
tf−idf(wi)=tf(wi)×log (M/df(wi))
as its elements may be used as the representation of the text data. Before these representations are formed, preprocessing for excluding nouns whose frequencies are less than a threshold may be performed.

The text data input means 1 may be implemented by typical information input means such as a keyboard for inputting text data, a program for transferring data from a call center database as needed, and an application for downloading text data from the Web.

The learning means 21 to 2n update mixture distributions 31 to 3n according to text data inputted through the text data input means 1. The mixture distributions 31 to 3n are inferred from text data inputted through the text data input means 1 as possible probability distributions for the inputted text data.

In general, in probabilistic models, given data x is regarded as a realization value of a random variable. In particular, assuming that the probability density function of the random variable is a fixed functional form f (x; a) having a parameter a of finite dimension, its family of probability density function
F={f(x; a)|a in A}
is called a parametric probabilistic model, where A is a set of possible values of a. Inferring the value of parameter a from data x is called estimation. For example, maximum likelihood estimation is commonly used in which logf (x; a) is regarded as a function (logarithmic likelihood function) of a and the value of a that maximizes the function is assumed to be the estimate.

A probabilistic model M given by the linear combination of multiple probabilistic models

$$\begin{matrix}M = \{ f ( x ; c1 , … , Cn , a1 , … , an ) \\ = Cl * f1 ( x ; a1 ) + … + Cn * fn ( x ; an ) \vert ai in Ai , \\ Cl + … + Cn = 1 , Ci > 0 , ( i = 1 , … , k ) \}\end{matrix}$$

is called a mixture model, its probability distribution is called a mixture distribution, the original distributions from which the linear combination is produced is called components, and Ci is the mixing weight of the i-th component. This is equivalent to a model generated by using y, which is an integer within the range from 1 to n, as a random variable and a hidden (latent) function and modeling only x of the random variable z=(y, x) that satisfies
Pr{y=i}=Ci, f(x|y=i)=fi(x; ai).

Here, the conditional density function of x is f (x|y=i) under the condition of y=i. For simplicity of later description, the assumption is that the probability density function of z=(y, x) is
g (z; C1, . . . , Cn, a1, . . . , an).

According to the present invention, models 31 to 3n are mixture models having different numbers of components and different parameters of components and each component is a probability distribution for text data that includes a particular main topic. That is, the number of components of a given model represents the number of main topics in a text data set and each component corresponds to each main topic.

Performing maximum likelihood estimation based on given data for a mixture model requires a huge amount of computations. One well-known algorithm for obtaining an approximate solution with a smaller amount of computations is the EM (Expectation Maximization) algorithm. In the EM algorithm, the calculation of the posterior distribution of a latent variable y and maximization of the average value Ey [log g (x|y)] obtained from the posterior distribution of the logarithmic likelihood of x weighted by the value of y are repeated to estimate the parameters of the mixture distribution, rather than directly maximizing the logarithmic likelihood. Here, the average obtained from the posterior distribution of Y is Ey [*].

Another well-known algorithm is the sequential EM algorithm in which the result of estimation of the parameters of a mixture distribution is updated as data is added in a situation where additional data is sequentially arrives, rather than being provided in bulk. In particular, Non-Patent Document 5 describes a method in which the order in which data arrives is taken into consideration, greater importance is assigned to data arrived recently and the effect of data arrived earlier is gradually decreased. According to the method, the total number of pieces of data that arrived is denoted by L, the l-th piece of data is denoted by xl, and the latent variable is denoted by yl, and the calculation of the posterior distribution of yl and the maximization of the logarithmic likelihood
ΣEyl[(l−r)^{(L-1)} rlog g(yl|xl)]
are sequentially performed, wherein the data arrived latest is given the highest weight.

Here, Σ denotes the sum of l=1 to L and Eyl [*] denotes the average obtained from the posterior distribution of yl. A special case of this method where r=0 is the sequential EM algorithm in which data are not weighted according to the order of arrival.

The learning means 21 to 2n of the present invention update the estimation of mixture distributions in the models 31 to 3n in accordance with the sequential EM algorithm whenever data is provided from the text data input means 1. Further, if timestamps are affixed to text data, learning may be performed in such a manner that
ΣEyl[(1−r)^{(L-1)}rlog g(xl, yl|yl)]
is maximized. Here, the timestamp of the l-th data is tl. This allows estimation to be performed consistently in such a manner that the latest data is given greater importance and the effect of older data are reduced, even if the data arrives at irregular intervals.

For example, imagine a mixture model having components that are Gaussian distributions. Then, the i-th component can be represented as a Gaussian density function having the average, μi, and the variance-covariance matrix, Σi, as its parameters as follows:
(1/(2π)^{d/2}|Σᵢ|) exp [−(½) (x−μᵢ)^{T}Σᵢ⁻¹(x−μᵢ)]
The number of components is denoted by k and the mixing ratio of the i-th component is denoted by ξᵢ.

Data that arrived at time t_{old} is denoted by xₙ and the average parameter, variance-covariance matrix parameter, and mixture weight of the i-th component before update are denoted by μᵢ^{old}, Σᵢ^{old}, and ξᵢ^{old} respectively. If new data Xₙ₊ᵢ is inputted at time t_{new}, the parameters after the update, μᵢ^{new}, Σᵢ^{new}, and ξᵢ^{new}, can be calculate by the following equations, where d, Wᵢⱼ, and sᵢ are ancillary variables.

$$\begin{matrix}P = \frac{1}{\begin{matrix}{\sum }_{i = 1}^{k} exp \{ log {{ξ}^{old}}_{l} + log ϕ ( {x}_{n + 1} \vert {{μ}^{old}}_{l} , {{Σ}^{old}}_{l} ) - \\ log {{ξ}^{old}}_{i} - log ϕ ( {x}_{n + 1} \vert {{μ}^{old}}_{i} , {{Σ}^{old}}_{i} ) \}\end{matrix}} & [ Formula 1 ] \\ {W}_{in + 1}^{new} = Wa ( P , \frac{1}{k} \vert 1 , α ) & [ Formula 2 ]\end{matrix}$$

where α is a user-specified constant.

$${{μ}_{i}}^{new} = WA ( {{μ}_{i}}^{old} , {x}_{n + 1} \vert {{ξ}_{i}}^{old} {d}^{old} , {λ}^{- ( {t}_{new} - {t}_{old} )} {W}_{in + 1}^{new} ) \qquad [ Formula 3 ]$$

where λ is a user-specified constant (discount rate).

$$\begin{matrix}{{S}_{i}}^{new} = WA ( {{S}^{old}}_{i} , {x}_{n + 1} {x}_{n + 1} \vert {{ξ}_{i}}^{old} {d}^{old} , {λ}^{- ( {t}_{new} - {t}_{old} )} {W}_{in + 1}^{new} ) & [ Formula 4 ] \\ {{Σ}_{i}}^{new} = {{S}_{i}}^{new} - {{μ}_{i}}^{new} {{μ}_{i}}^{new} & [ Formula 5 ] \\ {{ξ}_{i}}^{new} = WA ( {{ξ}_{i}}^{old} , {W}_{in + 1}^{new} \vert {d}^{old} , {λ}^{- ( {t}_{new} - {t}_{old} )} ) & [ Formula 6 ] \\ {d}^{new} = {λ}^{- ( {t}_{new} - {t}_{old} )} {d}^{old} + 1 & [ Formula 7 ]\end{matrix}$$

Here, representations that should be written
(expression. 1*expression. 3+expression. 2*expression. 4)/(expression. 3+expression. 4) is written

WA (expression. 1, expression. 2|expression 3, expression 4) for simplicity.

In the model selecting means 4, the value of information criterion for each of the possible probability distribution models 31 to 3n for inputted text data is calculated from text inputted by the text data input means 1 and the optimal model is selected. For example, if the size of a window is denoted by W, the dimension of vector representation of the t-th data is denoted by dt, and a mixture distribution made up of k components is represented by p^{(t)} (x|k), and its parameters have been updated sequentially since the t-th data was inputted, then the value I (k) of the information criterion when the n-th data is received can be calculated as
I(k)=(1/W)Σ_{t=n-w}ⁿ(−logP^{(t)}(xₜ|k))/dₜ

The number of components k that minimize this value is the optimal number of components and those components can be identified as the components representing main topics. Whenever new words appear as input text data is added and the dimension of the vector representing the data increases, the value of the criterion that accommodates the increase can be calculate. The components that constitute p^{(t)} (xₜ|k) may be independent components or subcomponents of a higher-level mixture model.

When the model selected by the model selecting means 4 changes, the topic generation and disappearance determining means 5 judges components in the newly selected model which do not have a component close to them in the previously selected model to be “newly generated topics” and judges components of the old model which do not have components close to them in the new model to be “disappeared topics”, and outputs them to the output means 7. As the measure of closeness between components, the p-value in a variance test of distributions or KL (Kullback Leibler) divergence, which is a well-known quantity for measuring the closeness between two probability distributions, may be used. Alternatively, the difference between the averages of two probability distributions may be used.

The topic feature extracting means 6 extracts a feature of each components of the model selected by the model selecting means 4 and outputs it to the output means 7 as feature representation of the corresponding topic. Feature representations can be extracted by calculating the information gain of words and extracting words having high gains. Information gains may be calculated as follows.

Given the t-th data, t is used as the number of pieces of data. The number of pieces of data which contain a specified word w in the entire data is denoted by m_{w}, the number of pieces of data which do not contain the word w is denoted by m′_{w}, the number of texts produced from a specified component (let this be the i-th component) is denoted by tᵢ, and the number of pieces of data originated from the i-th component in the data containing the word w is denoted by m_{w}⁺, and the number of pieces of data originated from the i-th component in the data that does not contain the word w is denoted by m_{w}⁺. Then, I (A, B) is used as the measure of the quantity of information to calculate the information gain of w
IG(w)=I(t, ti)−(I(m_{w}, m_{w}⁺)+I(m′_{w}, m′_{w}⁺))

Here, an entropy, probabilistic complexity, or extended probabilistic complexity may be used as an equation for calculating I (A, B). The entropy is represented by
I(A, B)=AH(B/A)=A(Blog (B/A)+(A−B) log ((A−B)/A))
The probabilistic complexity may is represented by
I(A, B)=AH (B/A)+(1/2) log (A/2π)
The extended probabilistic complexity is represented by
I(A, B)=min {B, A−B}+c(Alog A)^{1/2}

Instead of IG (w), an X-squared test statistic
(m_{w}+m′_{w})×(m_{w}⁺(m′_{w}−m′_{w}⁺)−(m_{w}−m_{w}⁺)m′_{w})×((m_{w}⁺+m′_{w}⁺)×(m_{w}−m_{w}⁺+m′_{w}−m′_{w}⁺)m_{w}m′_{w})⁻¹
may be used as the information gain.

For each i, the information gain of each w is calculated for the i-th component. Then, a specified number of words are extracted in descending order of information gain. Thus, the features words can be extracted. Alternatively, a threshold may be predetermined and the words that provide information gains that exceed the threshold may be extracted as feature words. Given the t-th data, statistics required for calculating the information gains are t, tᵢ, m_{w}, m′_{w}, m_{w}⁺, and m′_{w}⁺ for each i and w. These statistics can be calculated incrementally each time data is given.

The learning means and the models are implemented by cooperation by a microprocessor, such as a CPU, and its peripheral circuits, a memory storing the models 31 to 3n, and a program controlling their operation.

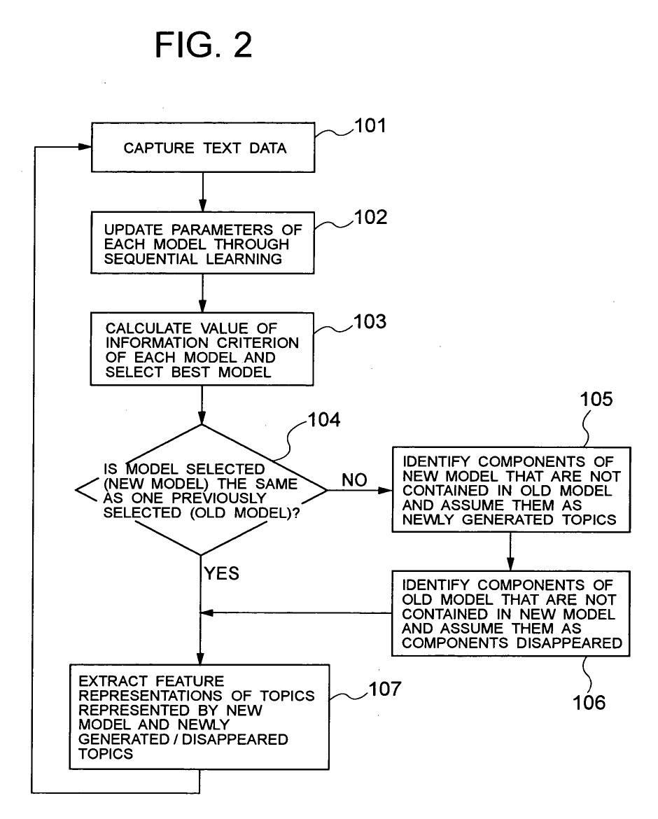

FIG. 2 is a flowchart of operation according to the present invention. At step 101, text data is inputted through the text data input means and converted into a data format for processing in the subsequent steps. At step 102, based on the converted text data, the inferred parameters of models are updated by the learning means. Consequently, new parameter values that reflect the values of data inputted are held by each model.

Then, at step 103, the optimal model is selected by the model selecting means from the stored models with consideration given to text data that have been inputted so far. The components of the mixture distribution in the selected model correspond to main topics.

At step 104, determination is made as to whether the model selected as a result of the data input is the same model that was selected on the previous occasion. If the selected model is the same as the previous one, it means that the new main topics have not been generated or disappeared by inputting the new data for main topics in the previous text data. On the other hand, if the selected model differs from the previous one, it typically means that the number of components of the mixture distribution has changed and new topics have been generated or disappeared.

Therefore, at step 105, the topic generation and disappearance determining means identifies the components in the components of the newly selected model that are not close to any of the components of the previously selected model. The identified components are assumed as the components that represent newly generated main topics. Similarly, at step 106, the components of the previously selected model that are not close to any of the components of the newly selected model are identified and assumed as the components representing topics that are no longer main components.

At step 107, the topic feature extracting means extracts features of the components of the selected model and the components that are assumed as newly generated or disappeared components. The extracted features are assumed as the feature representations of the corresponding topics. If an additional piece of text data is inputted, the process returns to step 101 and the process is repeated. Steps 103 to 107 do not necessarily need to be performed every piece of text data inputted. They may be performed only when an instruction to perform identification of main topics or newly generated/disappeared topics is issued by a user or at a time of day specified with a timer.

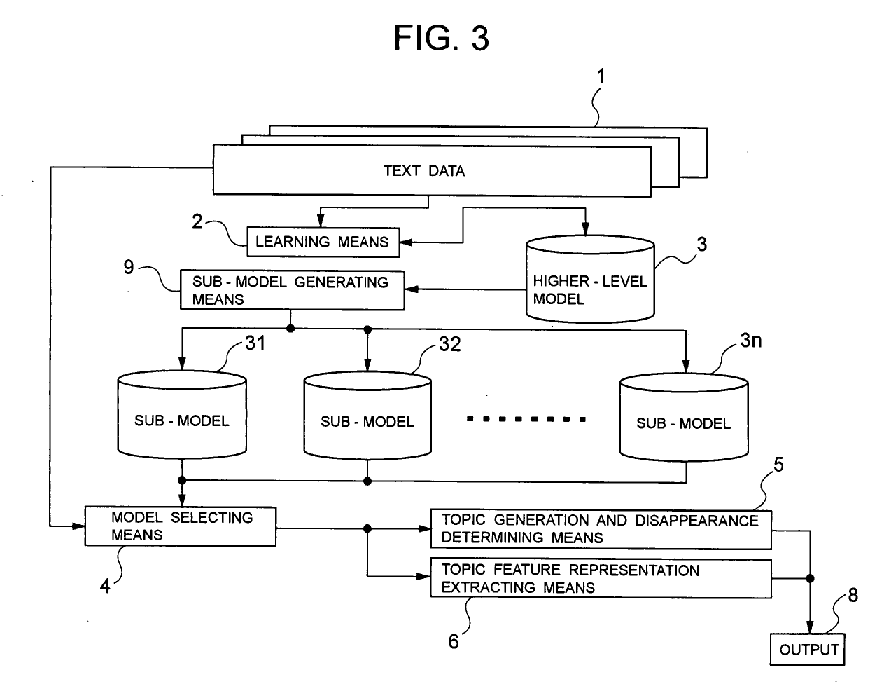

FIG. 3 is a block diagram showing a configuration of a topic analyzing apparatus according to a second embodiment of the present invention. The elements that are equivalent to those in FIG. 1 are denoted by the same reference numerals. The second embodiment differs from the first embodiment in that candidate models from which the model selecting means selects a model are a plurality of sub-models of a higher-level. A model is selected from among sub-models generated by sub-model generating means 9 in a manner similar to that in the first embodiment. For example, a mixture model having relatively many components is assumed as the higher-level model and mixture models generated by extracting some components from the higher-level model is assumed as the sub-model.

With this configuration, the needs for storing multiple models concurrently and for updating them by learning means can be eliminated, and the amount of memory and the amount of computation required for processing can be reduced. Furthermore, in the topic generation and disappearance determining means, by using information as to “whether two components were generated from the same component in the higher-level model” as the measure of the closeness between them, the amount of computation can be reduced compared with a case where the distance between probabilistic distributions is used as the measure.

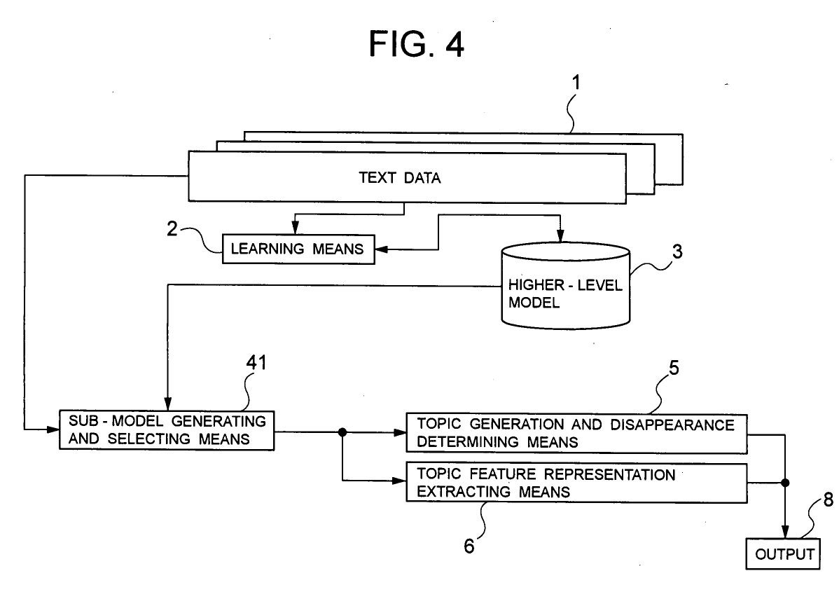

FIG. 4 is a block diagram showing a configuration of a topic analyzing apparatus according to a third embodiment of the present invention. The elements that are equivalent to those in FIGS. 1 and 3 are denoted by the same reference numerals. The candidate models from which the model selecting means in this embodiment selects a model are also a plurality of sub-models of a higher-level model as in the second embodiment. The third embodiment differs from the second embodiment in that the information criteria of multiple sub-models are calculated sequentially, rather than concurrently, by sub-model generating means 41 to select the optimal sub-model. With this configuration, the need for storing all sub-models is eliminated and therefore the amount of required memory capacity can be further reduced.

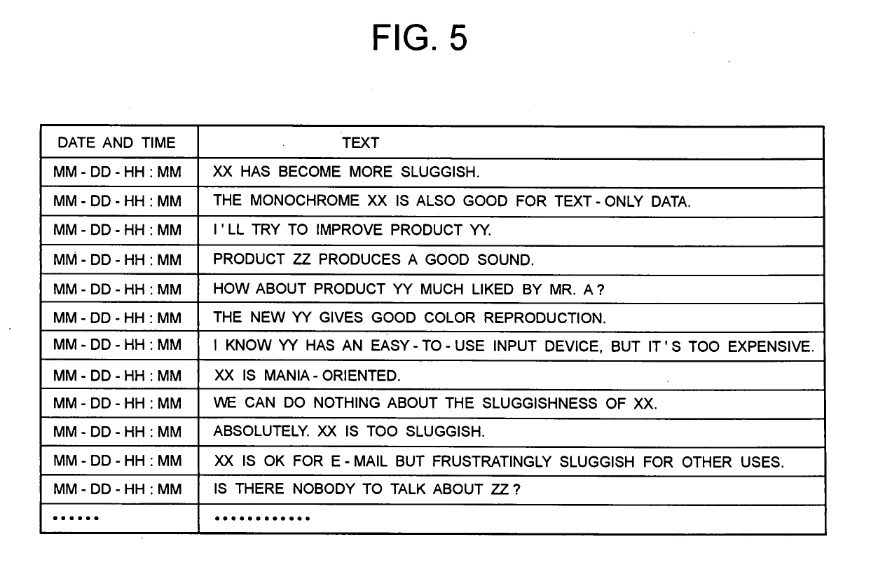

FIG. 5 shows an example of data inputted in the present invention. This is monitored data on a bulletin board on the Web on which discussion about electric appliances of a certain type, in which each posted message (text data) associated with the date and time at which it was posted constitutes one record. Messages are posted onto the Web bulletin board at any time and data are added at any time. Newly added data is inputted into a topic analyzing apparatus according to the invention by a program running according to a schedule or a bulletin board server and a series of processes are performed.

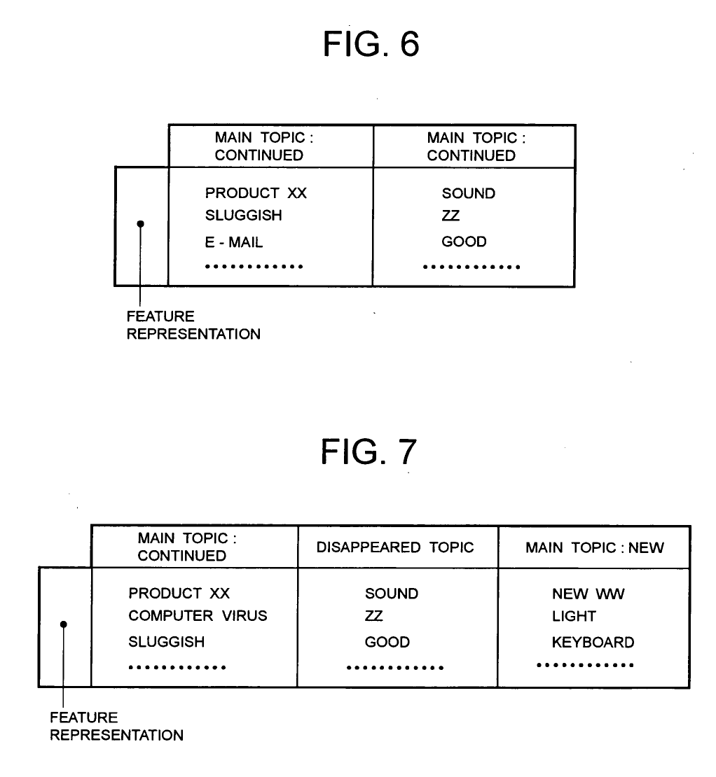

FIG. 6 shows an example of an output from topic analysis according to the present invention in which data has been inputted until a certain time. Each column corresponds to a main topic and is an output from topic feature representation extracting means for each component of a model selected by model selecting means. In this exemplary analysis, the selected model has two components: one is a main topic having feature representations such as “product XX”, “sluggish”, and “e-mail” and the other is a main topic having feature representations such as “sound”, “ZZ”, and “good”.

FIG. 7 shows an example of an output from topic analysis according to the present invention in which additional data has been furthermore inputted until a certain time. In this example a different model was selected by the model selecting means at the time. In this exemplary output, the topics that are judged to be newly generated topic by the topic generation and disappearance determining means have the column name of “Main topic: new”, the topics that are judged to be disappeared topics have the column name of “Disappeared topic”, and the topics corresponding to components of a newly selected model that are close to components of the previous model have the column name of “Main topic: continued”.

A topic having the feature word “product XX” has the column name of “Main topic: continued” and therefore is a preexisting main topic. As compared with the topic “product XX” in FIG. 6, however, the topic has the feature word “computer virus” instead of “e-mail”. Thus, a human analyzer can know that the contents of the same topic are changed.

The topic with the feature words “sound” and “ZZ” is a main topic in FIG. 6 whereas it is outputted as a “disappeared topic” in FIG. 7. It can be seen that the topic has disappeared after the analysis in FIG. 7. On the other hand, the topic with feature words such as “new WW” is identified as a “main topic: new” and accordingly the analyzer can know that it has newly become a main topic at the time.

A first advantage of the present invention is that main topics and their generation and disappearance can be identified at any time with a small amount of memory capacity and processing time by modeling time-series text data by using multiple mixture distributions and using discounting sequential learning algorithm to learn parameters and select a model. Timestamps of the data can be used to identify a topic structure, with the effect of older data decreasing with time. Further, whenever text data is added and the dimension of the vector representing the data increases because of the emergence of new words, optimum main topic can be identified adaptively.

A second advantage of the present invention is that a feature representation of each topic can be identified from parameters of learned mixture distributions to extract the contents of the topic at any time and thereby allowing a human analyzer to known even a change in a single topic.

1. A topic analyzing apparatus which detects topics while sequentially reading text data in a situation where the text data is added in time series, the apparatus comprising:
learning means for representing a topic generation model by a mixture distribution model and learning the topic generation model online while more-heavily discounting the older data on the basis of a timestamp of the data;
storage means for storing the generation model; and
means for selecting an optimal topic generation model from among a plurality of candidate topic generation models stored in the storage means, on the basis of information criteria of the topic generation models and detecting topics as mixture components of the optimal topic generation model.

2. A topic analyzing apparatus comprising topic generation and disappearance determining means for comparing mixture components of a topic generation model at a particular time with mixture components of a topic generation model at another time to determine whether or not a new topic has been generated and whether or not an existing topic has disappeared.

3. A topic analyzing apparatus comprising topic feature representation extracting means for extracting a feature representation of a topic corresponding to each of the mixture components of a topic generation model on the basis of a parameter of the mixture components to characterize each topic.

4. A topic analyzing apparatus which detects topics while sequentially reading text data in a situation where the text data is added in time series, the apparatus comprising:
learning means for representing a topic generation model by a mixture distribution model and learning the topic generation model online while more-heavily discounting the older data on the basis of a timestamp of the data;
storage means for storing the generation model;
means for selecting an optimal topic generation model from among a plurality of candidate topic generation models stored in the storage means, on the basis of information criteria of the topic generation models and detecting topics as mixture components of the optimal topic generation model; and
topic generation and disappearance determining means for comparing mixture components of a topic generation model at a particular time with mixture components of a topic generation model at another time to determine whether or not a new topic has been generated and whether or not an existing topic has disappeared.

5. The topic analyzing apparatus according to claim 4, further comprising topic feature extracting means for extracting a feature representation of a topic corresponding to each of the mixture components of a topic generation model on the basis of a parameter of the mixture components to characterize each topic.

6. A topic analyzing apparatus which detects topics while sequentially reading text data in a situation where the text data is added in time series, the apparatus comprising:
learning means for representing a topic generation model by a mixture distribution model and learning the topic generation model online while more-heavily discounting the older data on the basis of a timestamp of the data;
storage means for storing the generation model;
means for selecting an optimal topic generation model from among a plurality of candidate topic generation models stored in the storage means, on the basis of information criteria of the topic generation models and detecting topics as mixture components of the optimal topic generation model; and
topic feature extracting means for extracting a feature representation of a topic corresponding to each of the mixture components of a topic generation model on the basis of a parameter of the mixture components to characterize each topic.

7. A topic analyzing method for detecting topics while sequentially reading text data in a situation where the text data is added in time series, comprising the steps of:
representing a topic generation model by a mixture distribution model, learning the topic generation model online while more-heavily discounting the older data on the basis of a timestamp of the data and storing the topic generation model in storage means; and
selecting an optimal topic generation model from among a plurality of candidate topic generation models stored in the storage means, on the basis of information criteria of the topic generation models and detecting topics as mixture components of the optimal topic generation model.

8. A topic analyzing method, comprising the step of comparing mixture components of a topic generation model at a particular time with mixture components of a topic generation model at another time to determine whether or not a new topic has been generated and whether or not an existing topic has disappeared.

9. A topic analyzing method, comprising the step of extracting a feature representation of a topic corresponding to each of the mixture components of a topic generation model on the basis of a parameter of the mixture components to characterize each topic.

10. A topic analyzing method for detecting topics while sequentially reading text data in a situation where the text data is added in time series, comprising the steps of:
representing a topic generation model by a mixture distribution model, learning the topic generation model online while more-heavily discounting the older data on the basis of a timestamp of the data, and storing the topic generation model in storage means;
selecting an optimal topic generation model from among a plurality of candidate topic generation models stored in the storage means, on the basis of information criteria of the topic generation models and detecting topics as mixture components of the optimal topic generation model; and
comparing mixture components of a topic generation model at a particular time with mixture components of a topic generation model at another time to determine whether or not a new topic has been generated and whether or not an existing topic has disappeared.

11. The topic analyzing method according to claim 10, further comprising the step of extracting a feature representation of a topic corresponding to each of the mixture components of a topic generation model on the basis of a parameter of the mixture components to characterize each topic.

12. A topic analyzing method for detecting topics while sequentially reading text data in a situation where the text data is added in time series, comprising the steps of:
representing a topic generation model by a mixture distribution model, learning the topic generation model online while more-heavily discounting the older data on the basis of a timestamp of the data, and storing the topic generation model in storage means;
selecting an optimal topic generation model from among a plurality of candidate topic generation models stored in the storage means, on the basis of information criteria of the topic generation models and detecting topics as mixture components of the optimal topic generation model; and
extracting a feature representation of a topic corresponding to each of the mixture components of a topic generation model on the basis of a parameter of the mixture components to characterize each topic.

13. A program for causing a computer to perform a method for detecting topics while sequentially reading text data in a situation where the text data is added in time series, comprising the steps of:
representing a topic generation model by a mixture distribution model, learning the topic generation model online while more-heavily discounting the older data on the basis of a timestamp of the data and storing the topic generation model in storage means; and
selecting an optimal topic generation model from among a plurality of candidate topic generation models stored in the storage means, on the basis of information criteria of the topic generation models and detecting topics as mixture components of the optimal topic generation model.

14. A computer-readable program comprising the step of comparing mixture components of a topic generation model at a particular time with mixture components of a topic generation model at another time to determine whether or not a new topic has been generated and whether or not an existing topic has disappeared.

15. A computer-readable program comprising the step of extracting a feature representation of a topic corresponding to each of the mixture components of a topic generation model on the basis of a parameter of the mixture components to characterize each topic.

16. A program for causing a computer to perform a method for detecting topics while sequentially reading text data in a situation where the text data is added in time series, comprising the steps of:
representing a topic generation model by a mixture distribution model, learning the topic generation model online while more-heavily discounting the older data on the basis of a timestamp of the data, and storing the topic generation model in storage means;
selecting an optimal topic generation model from among a plurality of candidate topic generation models stored in the storage means, on the basis of information criteria of the topic generation models and detecting topics as mixture components of the optimal topic generation model; and
comparing mixture components of a topic generation model at a particular time with mixture components of a topic generation model at another time to determine whether or not a new topic has been generated and whether or not an existing topic has disappeared.

17. The program according to claim 16, further comprising the step of extracting a feature representation of a topic corresponding to each of the mixture components of a topic generation model on the basis of a parameter of the mixture components to characterize each topic.

18. A program for causing a computer to perform a method for detecting topics while sequentially reading text data in a situation where the text data is added in time series, comprising the steps of:
representing a topic generation model by a mixture distribution model, learning the topic generation model online while more-heavily discounting the older data on the basis of a timestamp of the data, and storing the topic generation model in storage means;
selecting an optimal topic generation model from among a plurality of candidate topic generation models stored in the storage means, on the basis of information criteria of the topic generation models and detecting topics as mixture components of the optimal topic generation model; and
extracting a feature representation of a topic corresponding to each of the mixture components of a topic generation model on the basis of a parameter of the mixture components to characterize each topic.
